(19) United States
(12) Patent Application Publication
(10) Pub. No.: US 2022/0335462 A1
(43) Pub. Date: Oct. 20, 2022

(54) Information Providing Method and Electronic Apparatus Performing the Same

(71) Applicant: Coupang Corp., Seoul (KR)

(72) Inventors: Su Jin Kyung, Seoul (KR); Eun Sol Lee, Seoul (KR); Seon II Kim, Seoul (KR)

(73) Assignee: Coupang Corp., Seoul (KR)

(21) Appl. No.: 17/394,702

(22) Filed: Aug. 5, 2021

(30) Foreign Application Priority Data
Apr. 16, 2021 (KR) 10-2021-0049906

(51) Int. Cl. G06Q 30/02

(52) U.S. Cl. CPC G06Q 30/0213; G06Q 30/0201; G06Q 30/0222; G06Q 10/0838

(57) ABSTRACT

An information providing method of an electronic apparatus according to various example embodiments may include obtaining information on at least one item, identifying brand membership-related information corresponding to the at least one item, and providing at least part of the brand membership-related information based on a specified condition. In addition, other example embodiments are possible.

### TECHNICAL FIELD

Example embodiments of the present disclosure relate to an information providing method and an electronic apparatus performing the same.

### DESCRIPTION OF THE RELATED ART

With the development of Internet technology and the spread of portable terminals such as smartphones and tablet PCs, the e-commerce market is commercialized. In particular, in recent years, the proportion of users (consumers, buyers) visiting offline stores directly to purchase items has somewhat decreased due to the spread of infectious diseases, while the proportion of purchasing items online in the e-commerce market using PCs or mobile terminals is gradually increasing.

Meanwhile, in the e-commerce market, the manufacturer of items or the brand of items may have a major influence on selecting an item for a user to purchase. For example, when purchasing an item online, users may feel burdened because they have to select an item to purchase by looking at the image or description of the item without directly touching or visually checking the item. In the end, it is highly likely to use the existing purchase experience of items to select an item to purchase depending on the manufacturer or brand. In other words, in the e-commerce market, the competitiveness of the brand can be a more important factor in the sale/purchase of items than in the offline market.

Accordingly, the seller (or manufacturer) operates a brand membership service for the items they sell to preferentially promote the brand's items to specific target users or provide users who show interest in their brand with a purchase benefit service that is distinct from those for other users. For example, a user who has subscribed to a membership of a specific brand may be informed of new item information in advance when a new item related to the brand is released from a seller, and may receive a certain purchase benefit in relation to the brand item.

However, in the conventional case, there was an inconvenience in that users had to subscribe to each brand membership at each site operated by each brand, and the seller side also had difficulty in providing item promotion or purchase benefit information on the platform integrated with the sales site.

### DISCLOSURE OF THE INVENTION

### Technical Goals

An aspect of the present disclosure is to provide a method of providing information of an electronic apparatus and an electronic apparatus performing the same, capable of providing an integrated management function for brand membership in an electronic apparatus that provides a platform for selling items, such as guiding a user to subscribe to a brand membership related to an item purchased by a user in an e-commerce system, or providing benefit information related to the subscribed brand membership.

### Technical Solutions

According to an aspect, there is provided an information providing method of an electronic apparatus including obtaining information on at least one item, identifying brand membership-related information corresponding to the at least one item, and providing at least part of the brand membership-related information based on a specified condition.

For example, the obtaining of the information on the at least one item may include obtaining information on at least one item purchased by a user.

For example, the providing of the at least part of the brand membership-related information may include:

identifying whether the user subscribes to the brand membership; and providing any one of subscription guide information for the brand membership or benefit information related to the brand membership based on whether the user subscribes to the brand membership.

For example, the identifying of the brand membership-related information may include identifying the brand membership-related information corresponding to the at least one item among a plurality of brand membership-related information corresponding to a plurality of items stored in a database in advance.

For example, the providing of the at least part of the brand membership-related information may include providing information associated with a predetermined brand membership to which the user is to subscribe based on the user's purchase history information.

For example, the providing of the at least part of the brand membership-related information may include providing the brand membership-related information corresponding to at least one of delivery address information or payment area information related to the purchase of the at least one item.

For example, the providing of the at least part of the brand membership-related information may include determining whether to provide the brand membership-related information in response to a completion of delivery of the at least one item to the user based on delivery information of the at least one item.

For example, the providing of the at least part of the brand membership-related information may include providing at least part of the brand membership-related information based on a user input for confirming a purchase of the at least one item.

For example, the providing of the at least part of the brand membership-related information includes providing the brand membership-related information on a user interface displaying purchase completion notification information of the at least one item.

For example, the providing of the at least part of the brand membership-related information may include identifying item category information corresponding to the at least one item, and providing the at least part of the brand membership-related information based on the item category information.

For example, the specified condition may include at least one of a payment count-related condition, a payment amount-related condition, and a payment method-related condition for the at least one item or at least one among other items of a brand corresponding to the at least one item, and the providing of the at least part of the brand membership-related information may include providing the at least part of the brand membership-related information satisfying the specified condition.

According to another aspect, there is provided an electronic apparatus including a communication module, a database, and a processor electrically connected to the database, wherein the processor is configured to obtain information on at least one item purchased by a specific user, identify brand membership-related information corresponding to the at least one item, and provide at least part of the brand membership-related information based on a specified condition.

### Effects

According to various example embodiments, by guiding a user to subscribe to a brand membership related to an item purchased by the user in an e-commerce system, or providing benefit information related to the subscribed brand membership, a seller can get an opportunity to promote items of a specific brand, and, from a user's point of view, it is possible to increase purchase satisfaction in online shopping by enjoying purchase benefits of items.

### BRIEF DESCRIPTION OF THE DRAWINGS

FIG. 1 is a schematic diagram illustrating an information providing system according to various example embodiments of the present disclosure.

FIG. 2 is a schematic block diagram of an electronic apparatus according to an example embodiment of the present disclosure.

FIG. 3 is a flowchart illustrating a method of providing information by an electronic apparatus according to an example embodiment of the present disclosure.

FIGS. 4A and 4B are diagrams schematically illustrating a user interface screen provided by an electronic apparatus according to an example embodiment of the present disclosure.

FIGS. 5A to 5C are diagrams schematically illustrating a user interface screen provided by an electronic apparatus according to an example embodiment of the present disclosure.

FIGS. 6A to 6H are diagrams schematically illustrating a user interface screen provided by an electronic apparatus according to an example embodiment of the present disclosure.

### DETAILED DESCRIPTION FOR CARRYING OUT THE INVENTION

The terms used in the example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “includes” a certain component, it means that other components may be further included, and it does not preclude other components, unless otherwise stated. In addition, terms such as “ . . . unit”, “ . . . module” described in the specification mean a unit for performing at least one function or operation, which may be implemented as hardware or software, or as a combination of hardware and software.

Throughout the specification, expression “at least one of a, b, and c” may include ‘a only’, ‘b only’, ‘c only’, ‘a and b’, ‘a and c’, ‘b and c’, or ‘all of a, b, and c’.

The “terminal” mentioned below may be implemented as a computer or a portable terminal that can access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, or the like.

Example embodiments of the present disclosure will be described in detail with reference to the accompanying drawings so that those skilled in the art may easily implement the present disclosure. However, the present disclosure may be implemented in various different forms and is not limited to the example embodiments described herein.

Example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

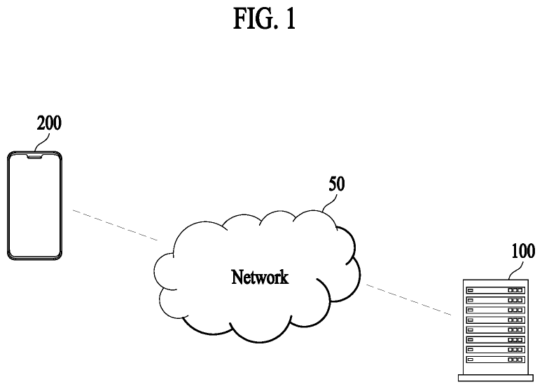

FIG. 1 is a schematic diagram illustrating an information providing system according to various example embodiments of the present disclosure.

According to various example embodiments, the information providing system may include at least one of an electronic apparatus 100 (e.g., a server), a user terminal 200, and a network 50.

The electronic apparatus 100 is an apparatus that performs a series of functional processing for providing various pieces of information related to item sales in an e-commerce. It may perform set operations based on a user input received from the user terminal 200 through the network 50 and provide the user terminal 200 with information corresponding thereto.

For example, the electronic apparatus 100 may include a plurality of computer systems or computer software implemented as a network server. For example, the electronic apparatus 100 may refer to a computer system and computer software that is connected to a lower-level apparatus capable of communicating with another network server through a computer network such as an intranet or the Internet to receive a request to perform a task, perform a task on it, and provide a result of the task. In addition, it can be understood as a broad concept including a series of application programs that can operate on a network server and various databases built therein. For example, the electronic apparatus 100 may be implemented using a network server program variously provided according to an operating system such as DOS, Windows, Linux, UNIX, MacOS, or the like.

For example, the electronic apparatus 100 may manage and provide information on predetermined items that a user can purchase, and further manage and provide information related to respective brand memberships corresponding to various items. For example, the electronic apparatus 100 may categorize and provide brand membership-related information associated with a predetermined item (e.g., an item purchased by a user) corresponding to specific user information (e.g., user identification information or user account information). For example, the electronic apparatus 100 may obtain and manage membership-related information of each brand from an external apparatus (e.g., a brand management server, a seller's apparatus, etc.).

For example, the electronic apparatus 100 may list brand memberships to which a user can subscribe, or may provide brand membership benefit information subscribed by the user, based on predetermined items corresponding to user information. In addition, as a request input to cancel the registration (subscription) of a specific brand membership is received from a user, the electronic apparatus 100 may exclude the brand membership from the subscribed brand membership list and may not provide the brand membership-related benefit information.

The electronic apparatus 100 may function as a front-end server providing the above various pieces of information related to item sales (e.g., item information, brand membership-related information, etc.) in the form of a user interface displayed through a web page or an application installed on the user terminal 200. However, this is only an exemplary description, and in various example embodiments, the electronic apparatus 100 may also be implemented to transmit related information to a separate front-end server and provide data related to a display screen from the front-end server to the user terminal 200.

The network 50 may serve to connect the electronic apparatus 100 and the user terminal 200, or the electronic apparatus 100 and an external apparatus (e.g., a distribution management server, etc.). For example, the network 50 may provide an access path so that the user terminal 200 or an external apparatus may be connected to the electronic apparatus 100 to transmit and receive packet data.

For example, the user terminal 200 may be connected to the electronic apparatus 100 or another external apparatus through the network 50 to transmit and receive item sales-related information for implementing an e-commerce.

The electronic apparatus 100 may store information received from the user terminal 200 or another external apparatus in a database, or transmit information stored in the database to the user terminal 200 or an external apparatus.

For example, the electronic apparatus 100 may provide a platform for an online store. Specifically, the electronic apparatus 100 may provide an application for using an online store to the user terminal 200, and the electronic apparatus 100 may execute the application to purchase an item. For example, the electronic apparatus 10 may be included in a server operating an online store.

Meanwhile, in various example embodiments, at least some functions that can be processed by the electronic apparatus 100 may also be implemented through the user terminal 200. For example, a user may receive an information providing system-related program of an application type through the network 50 to install and use it in the user terminal 200, and the application-type program may perform at least some functions processed by the electronic apparatus 100 to be described later.

The information providing system according to various example embodiments may be implemented as a single physical apparatus, or may be implemented in a manner in which a plurality of physical apparatuses are organically combined. For example, some of the functions provided by the electronic apparatus 100 may be implemented by any one physical apparatus, and some of the functions may be implemented by another physical apparatus. For example, one physical apparatus may be implemented as a part of the electronic apparatus 100, and another physical device may be implemented as a part of the user terminal 200 or a part of other external apparatus. In some cases, each component included in the information providing system is distributed and arranged in different physical apparatuses, and the distributed components are organically combined to be implemented to perform functions and operations of the information providing system of the present disclosure.

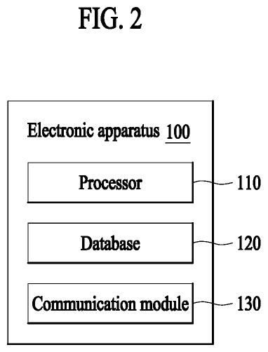

FIG. 2 is a schematic block diagram of an electronic apparatus according to an example embodiment of the present disclosure.

Referring to FIG. 2, the electronic apparatus 100 (e.g., a server) according to various example embodiments may include at least one of a processor 110, a database 120, and a communication module 130.

The processor 110 may process various functions for performing an information providing method according to various example embodiments of the present disclosure, and may be connected with other components of the electronic apparatus 100 (e.g., the database 120, the communication module 130) to control the overall operation of the components.

For example, the processor 110 may obtain predetermined information (e.g., specific item information, user information, brand membership information related to an item, etc.) using the communication module 130, and store and manage the information in the database 120. In addition, specific information processed by the processor 110 can be provided to an external apparatus (for example, the user terminal 200 or a front-end server, etc.) using the communication module 130.

For example, the processor 110 may obtain information related to at least one item selected by a user or purchased by the user, and check whether there is information related to brand membership corresponding to the at least one item.

For example, when the at least one item includes an item “A1” of brand A and an item “B1” of brand B, the processor 110 may check whether there are membership-related information corresponding to brand A and membership-related information corresponding to brand B, respectively. For example, a brand A sales company may be running a promotion event related to a brand A membership, and may have provided brand membership-related information to the electronic apparatus 100, and accordingly, the processor 110 may have obtained the membership-related information of brand A and stored in the database 120. Meanwhile, the brand B sales company may not be running a promotion related to the membership of brand B, and thus, information related to the brand B membership may not be stored in the database 120. In this case, the processor 110 may only identify information related to brand A membership from the database 120 based on item information about the item “A1” and the item “B1”.

Meanwhile, the processor 110 may determine, based on a specified condition, whether the identified brand membership-related information satisfies the specified condition.

For example, the processor 110 may check whether the user has subscribed to the brand membership, and only when it is determined that the user has not subscribed to the brand membership, the processor 110 may provide information for guiding the subscription to the brand membership as brand membership-related information. In addition, the processor 110 may identify whether the unsubscribed brand membership can be subscribed by the user based on the user's purchase history information, and the subscription guide information may be limited to the brand membership to which the user is eligible for subscription. For example, when it is determined that the user is not eligible for the brand membership, the processor 110 may provide at least one of subscription condition information and subscription benefit information of the brand membership.

For example, if it is determined that the user has already subscribed to the brand membership, the processor 110 may provide at least one of benefit information related to the brand membership, the user's level information in the brand membership, benefit information corresponding to the level, and sales information of other items corresponding to the brand. For example, the processor 110 may provide, based on the user's purchase history information, information on conditions for upgrading the user's level in relation to the brand membership (e.g., achieving VIP level when purchasing N additional purchases of the same brand item).

Meanwhile, the processor 110 may provide information related to brand membership of a purchased item based on delivery information of the item. For example, the processor 110 may receive delivery information of the purchased item from an external apparatus, such as a distribution management server, using the communication module 130. For example, when it is determined that the delivery of the purchased item to the delivery destination set at the time of purchase is completed based on the delivery information, the processor 110 may provide the brand membership-related information to the user terminal 200 as a response to the delivery completion.

As another example, when receiving a user input confirming a purchase of an item, the processor 110 may provide the brand membership-related information in response to the user input. For example, the processor 110 may provide the brand membership-related information only when delivery and purchase confirmation of a specific item are completed.

The processor 110 may, for example, classify brand membership-related information based on a predetermined item category, and provide at least some brand membership-related information that satisfies a condition set based on the classified category information. For example, the processor 110 may provide a function to subscribe or cancel subscription to a brand membership belonging to a corresponding category in an item category unit. According to an example embodiment, a specified condition related to brand membership subscription may correspond to a category unit, and the processor 110 may identify whether the specified condition of the category unit is satisfied based on whether the user has purchased items belonging to a specific item category using a specified payment method for a set number of times or a set payment amount.

For example, the processor 110 may provide at least part of brand membership-related information that satisfies a set condition based on at least some of payment count information, payment amount information, or payment method information.

In addition, the processor 110 may implement various functions related to provision of information according to various example embodiments of the present disclosure to be described later.

The database 120 is a data structure implemented in a predetermined storage space of the electronic apparatus 100, and functions such as storing, searching, deleting, editing, or adding data may be freely performed. For example, the database 120 may have fields or elements for processing functions such as storing, searching, deleting, editing, or adding data.

The database 120 may store data related to various functions of the electronic apparatus 100. For example, the database 120 may store various types of data related to an information providing method according to various example embodiments of the present disclosure, and may store instructions or data for an execution operation of the processor 110.

The communication module 130 may perform functions of transmitting information stored in the database 120 of the electronic apparatus 100 or predetermined information processed by the processor 110 to another apparatus, or receiving information from another apparatus to the electronic apparatus 100. For example, the communication module 130 may receive predetermined user input information (e.g., an item of interest setting input, an item search input, a delivery address setting input, a payment request input, etc.) from the user terminal 200. For example, the communication module 130 may include a transceiver for transmitting and receiving information.

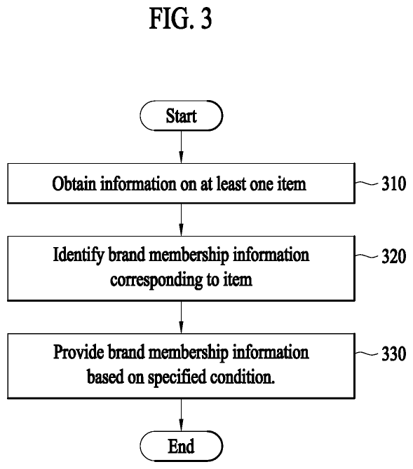

FIG. 3 is a flowchart illustrating a method of providing information by an electronic apparatus according to an example embodiment of the present disclosure.

Referring to FIG. 3, according to an information providing method according to various example embodiments, the electronic apparatus 100 (for example, the processor 110) may obtain information on at least one item in operation 310.

In operation 310, the electronic apparatus 100 may check the information on at least one item corresponding to a user (or corresponding to a user identifier (e.g., user account information)). For example, the electronic apparatus 100 may check the information on at least one of the item(s) for which a user has completed an order and a payment to complete a purchase (for example, a purchase confirmation item), item(s) related to a search result searched by the user using a specific search word, or item(s) designated by the user as an item of interest.

As an example, in operation 310, the electronic apparatus 100 may obtain the information related to at least one item purchased by a specific user. For example, the user terminal 200 may receive a user input (e.g., order/purchase request input, payment input, etc.) related to a purchase for a certain item, and the electronic apparatus 100 may obtain the user's item order information (or item purchase information) based on such purchase-related user input information. For example, the electronic apparatus 100 may store information on item(s) purchased by a user for a predetermined period in the database 120. For example, the electronic apparatus 100 may receive item purchase information from the user terminal 200 (or an external server that performs an operation related to purchase approval) in real time, and may store or manage the received item purchase information.

As another example, the electronic apparatus 100 may obtain information about an item selected by the user (e.g., item(s) selected by the user to check detailed information thereof) or item(s) designated by the user as an interest list (e.g., shopping cart list)). For example, the electronic apparatus 100 uses information on certain items selected by the user to check the brand membership-related benefit information that can be provided in relation to the item if the user purchases the item even though the user has not yet purchased the item and may provide it to the user terminal 200.

In operation 320, the electronic apparatus 100 (for example, the processor 110) according to various example embodiments may identify information related to at least one brand membership in relation with the item, based on the information on the at least one item obtained in operation 310.

For example, each item may or may not be mapped to a predetermined brand membership. Some item manufacturers may not provide brand membership services for branded items they sell. The electronic apparatus 100 may identify brand membership-related information for a predetermined item for which a corresponding brand membership exists among the at least one item.

For example, the electronic apparatus 100 may store brand membership-related information mapped to a plurality of items in the database 120 in advance. When purchase information on a specific item is received, the electronic apparatus 100 may check whether there is brand membership-related information corresponding to the item from the database 120. For example, the purchase information on the item may include at least one of category information of the item purchased by a user, brand information of the item, and purchase price information of the item.

For example, when the electronic apparatus 100 confirms that a specific user has purchased a company A brand item “A1”, company B brand items “B1” and “B2”, and a company C brand item “C1”, respectively, it is possible to identify the brands (brand A, brand B, and brand C) corresponding to respective items, and whether respective brand sales companies operate the brand membership service, that is, whether the brand membership information corresponding to the brands of respective items are present. For example, the electronic apparatus 100 may identify that brand membership information exist only for at least some of the respective brands (e.g., brand A and brand B).

Next, in operation 330, the electronic apparatus 100 (for example, the processor 110) according to various example embodiments may provide at least some of the brand membership-related information identified in operation 320 based on a specified condition.

For example, when one or more items for which brand membership-related information exist among the items purchased by the user are identified, the electronic apparatus 100 may check whether the user has already subscribed to the brand membership service in relation to the brand membership corresponding to each of the identified items. The electronic apparatus 100 may provide subscription guide information for a corresponding brand membership in operation 330 only when the user has not subscribed to the brand membership service.

Meanwhile, if it is determined that the user has already subscribed to the brand membership service, in operation 330, the electronic apparatus 100 may provide information related to a level of the corresponding brand membership or provide benefit information corresponding to the user's level or brand item promotion information.

Meanwhile, according to an example embodiment, when the electronic apparatus 100 identifies at least one item in which brand membership-related information exists among predetermined purchased items, it may check information related to brand membership to which the user can subscribe among the brand membership-related information corresponding to the identified item.

For example, the electronic apparatus 100 may check at least one brand membership-related information to which subscription eligibility is granted based on the user's purchase history information (e.g., purchase price information, purchase count information, purchase time information, purchase method information, etc.).

For example, some brand memberships may have set a condition related to a number of payments for a brand item (e.g., eligible for a brand membership when purchasing items corresponding to the brand N times or more), a condition related to a payment amount (e.g., eligible for a brand membership when purchasing more than 100,000 won), and a condition related to a payment method (e.g., eligible for a brand membership when purchasing a brand item using a specific credit card or points) in advance. For example, in operation 330, the electronic apparatus 100 may check whether conditions set for the brand membership are satisfied, extract only information related to brand membership that is confirmed to be available for a user to subscribe, and provide it.

Meanwhile, each brand membership-related information (e.g., brand membership subscription guide information or brand membership-related benefit information, etc.) may be provided differently according to country information corresponding to the user. For example, the electronic apparatus 100 may check delivery destination information or payment area information related to a purchase of a corresponding item based on the purchase item information or user account information, and may identify country information corresponding to the user based on this. For example, in a specific brand membership service, when a different brand membership policy for each country is applied, the electronic apparatus 100 may provide corresponding brand membership-related information based on the set country information.

According to some example embodiments, the electronic apparatus 100 may receive delivery information of a purchased item from an external apparatus (e.g., a distribution management server), and determine whether to provide the brand membership-related information based on the delivery information. For example, the electronic apparatus 100 may check whether an item purchased has been delivered to a delivery destination set by a user (or whether an item has been shipped from a set fulfillment center) based on the delivery information. For example, the electronic apparatus 100 may be set to output the brand membership-related information corresponding to the item to the user terminal 200 of the user in response to the completion of delivery of the item to the set delivery destination.

For another example, the electronic apparatus 100 may provide the brand membership-related information of the item based on receiving a user input confirming the purchase of the item after delivery of the item is completed. That is, the electronic apparatus 100 may determine that the purchase of the item has not been completed until the delivery of the item is completed and a user input related to the purchase confirmation is received, and only after the delivery of the item is completed and a user input confirming the purchase of the item is received from the user terminal 200, it is determined that the purchase of the item has been completed, and the brand membership-related information may be output. According to another example embodiment, the electronic apparatus 100 may automatically confirm the completion of the purchase when a user input regarding the purchase confirmation is not received from the user for a set period (e.g., N days) after delivery is completed.

However, it is not limited thereto, and according to an example embodiment, the electronic apparatus 100 may immediately output the brand membership-related information for an item that has been paid in response to a user's payment completion. For example, considering the case where the user checks the output of the brand membership-related information and subscribes to a specific brand membership immediately after completing the payment, but the payment for the item is canceled later due to reasons such as a refund request, delivery delay, or return, when the brand membership-related information is output in response to the completion of the payment and a subscription request input for the brand membership is received from the user, the electronic apparatus 100 may temporarily store the information on the subscription request input to a specific date (e.g., when delivery is completed, when a user input regarding purchase confirmation is received after delivery is completed, when a specific time has passed after delivery is completed, etc.) and transmit the user's subscription information to an external brand membership management server only when a payment cancellation does not occur by the specific date.

Meanwhile, when a specific item has been purchased, the electronic apparatus 100 may provide a user with an interface screen (e.g., thank you page) to inform the user that the purchase of the item has been completed. At this time, the electronic apparatus 100 may provide brand membership-related information related to the purchased item on the user interface displaying the purchase completion information.

For example, the brand membership-related information may include at least some of information that guides to subscribe to the brand membership service (e.g., link information that allows to switch the screen to the subscription consent page of the brand membership, etc.), information on the benefits that can be enjoyed when subscribing to the brand membership service, information on the user level of the brand membership and benefit information corresponding to the above level if the user has already subscribed to the brand membership, and recommendation information on other items related to the brand.

Meanwhile, according to an example, the electronic apparatus 100 may provide membership list information on respective brand(s) subscribed by a user, and in particular, the brand membership list may be classified and provided according to a specific category (e.g., a cosmetic category, a clothing category, a food and beverage category, etc.). In this case, the electronic apparatus 100 receives a user input for managing brand membership (e.g., subscription (registration) or unsubscription (subscription cancellation)) in a category unit, and, in response to the received user input, brand membership(s) included in the category may be collectively managed in a category unit.

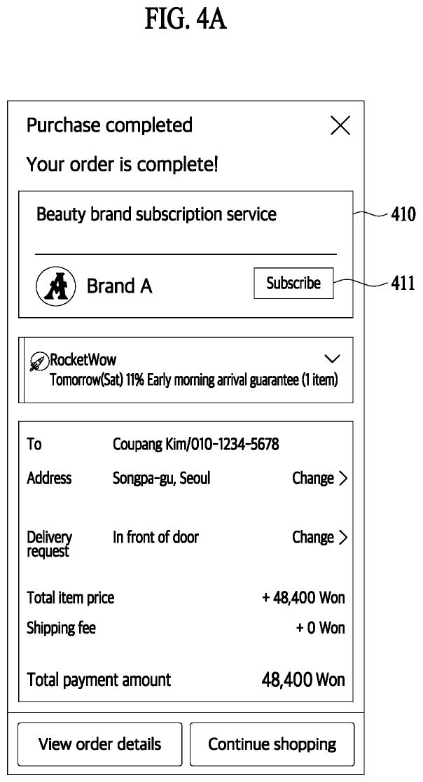

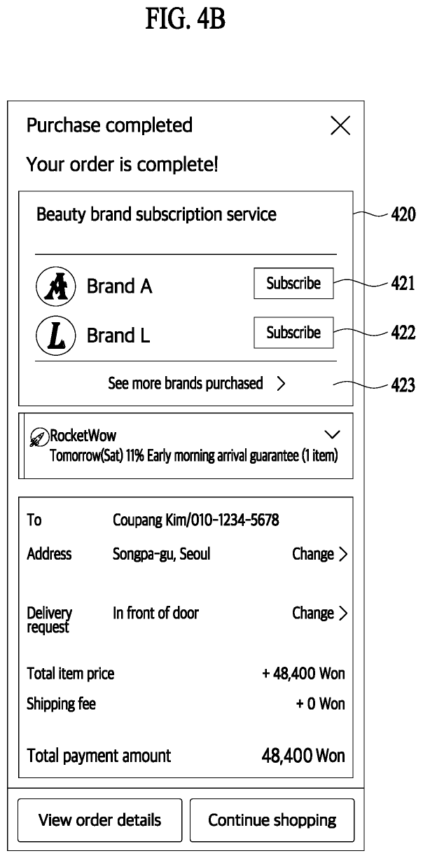

FIGS. 4A and 4B are diagrams schematically illustrating a user interface screen related to purchase completion information provided by an electronic apparatus according to an example embodiment of the present disclosure.

Referring to FIGS. 4A and 4B, when at least one item is purchased (or ordered), the electronic apparatus 100 according to an example embodiment may provide a user interface screen (or web page) information for informing a purchase completion (or order completion) of the item. For example, the electronic apparatus 100 may provide the information to the user terminal 200, and the user may, through the user terminal 200, check the user interface screen on which the purchase completion information of the item is displayed.

Referring to FIG. 4A, the electronic apparatus 100 according to an example embodiment may provide brand membership-related information 410 related to the purchased item on the user interface informing the purchase completion of the item.

For example, when a user purchases a specific item of brand A, the electronic apparatus 100 may provide, in response to the purchase completion of the item, at least one of delivery schedule information related to the purchased item (e.g., “Tomorrow (Saturday) early morning arrival delivery”), delivery address information (e.g., “receiving address: Songpa-gu, Seoul”) and payment amount information (e.g., total item price, shipping fee, discount price, total payment amount, etc.) on the user interface related to the purchase completion information.

In addition, the electronic apparatus 100 may provide the membership-related information 410 of a brand (e.g., brand A) corresponding to the purchased item on the user interface related to the purchase completion information. For example, in the brand membership-related information 410, a mark or brand name of the brand may be displayed, and a “Subscribe” button (or, an icon) 411 may be further displayed.

When only one brand membership-related information among at least one item purchased by the user is identified as a brand to recommend subscription to the user, as shown in FIG. 4A, the electronic apparatus 100 may provide only the one brand membership-related information 410 on the user interface.

Even when there are two or more brand memberships corresponding to the purchased item, the electronic apparatus 100 may provide only one of a plurality of brand memberships on the user interface related to the purchase completion information. For example, when a user purchases an item of brand A and an item of brand B at the same time, the electronic apparatus 100 may check brand A membership and brand B membership as brand memberships corresponding to the purchased items, respectively. For example, when a user subscribes to only one of them and does not subscribe to the other, the electronic apparatus 100 may provide only information on brand membership to which the user has not subscribed. On the other hand, if the user does not subscribe to either brand A membership or brand B membership, the electronic apparatus 100 may provide only one brand membership-related information based on a preset priority-related condition among the plurality of brand memberships. For example, the electronic apparatus 100 may select one brand membership based on user preference information related to each brand membership, or select a brand membership that provides the best benefits, and select any one brand membership to provide only one selected brand membership-related information.

Meanwhile, although not shown, according to an example embodiment, in order to induce a user to subscribe to a specific brand membership related to an item purchased by the user, the electronic apparatus 100 may also provide information on certain benefits that the user can receive when subscribing to the brand membership. In this regard, the electronic apparatus 100 may directly display the brand membership benefit information on the user interface informing the purchase completion, and in addition to this, the electronic apparatus 100 may also provide a link or icon information (e.g., “View benefits” button) that switches to another user interface related to the detailed benefit information of the brand membership. For example, the user interface screen related to the purchase completion information displayed on the user terminal 200 may be switched to a user interface which displays information related to brand membership benefits based on a user input to the link or icon (e.g., “View benefits” button).

Meanwhile, in FIG. 4A, the description is made on the premise that the electronic apparatus 100 determines that the user has not subscribed to the brand membership corresponding to the purchased item. However, according to another example embodiment, if the user has already subscribed to the brand membership corresponding to the purchased item, the electronic apparatus 100 may also display information on other recommended items of the brand membership, information on currently applicable benefits, or current membership level information (e.g., level conditions, level benefits, etc.) on the user interface related to the purchase completion information.

Referring to FIG. 4B, when there are two or more brand memberships corresponding to a purchased item, the electronic apparatus 100 according to another example embodiment may provide brand membership-related information 420 about at least some (e.g., brand A and brand L) of a plurality of brand memberships on the purchase completion page. The brand membership-related information 420 may include a mark and a brand name for each brand, and link information (e.g., “Subscribe” buttons 421 and 422) for subscribing to a membership of each brand.

For example, if the number of brand memberships to which a user can subscribe in response to the purchased item is one or two, the electronic apparatus 100 may only expose information on the corresponding brand membership(s) on the purchase completion page. For example, if the number of brand memberships to which a user can subscribe in response to the purchased item is more than two, the electronic apparatus 100 may only expose information related to two brand memberships based on a preset condition among them on the purchase completion page and may additionally provide information on a link (e.g., “See more brands purchased” button 423) for checking information related to other eligible brand memberships. For example, in response to receiving a user input for clicking the link, the electronic apparatus 100 may control to display information on a list of all brand memberships available for subscription in response to a current purchase.

According to an example embodiment, the electronic apparatus 100 may display information on two brand memberships to which a user is likely to subscribe on the purchase completion page screen, based on brand membership preference information of other users. According to another example embodiment, the electronic apparatus 100 may select a brand membership having excellent benefit information (e.g., a discount rate) and display information about the corresponding brand membership on the purchase completion page with priority. In addition, the electronic apparatus 100 may select a brand membership to be displayed on the purchase completion page in the order of the highest sales price of the item, or may select a predetermined number (for example, two) of brand memberships to be displayed on the purchase completion page in another setting method.

Meanwhile, in various example embodiments, the number of brand memberships displayed on the purchase completion page by the electronic apparatus 100 may be one or three or more. For example, the electronic apparatus 100 may display information on three brand memberships on the purchase completion page, and when there are more than three brand memberships to which a user can subscribe, a “See more brands purchased” button can be exposed together.

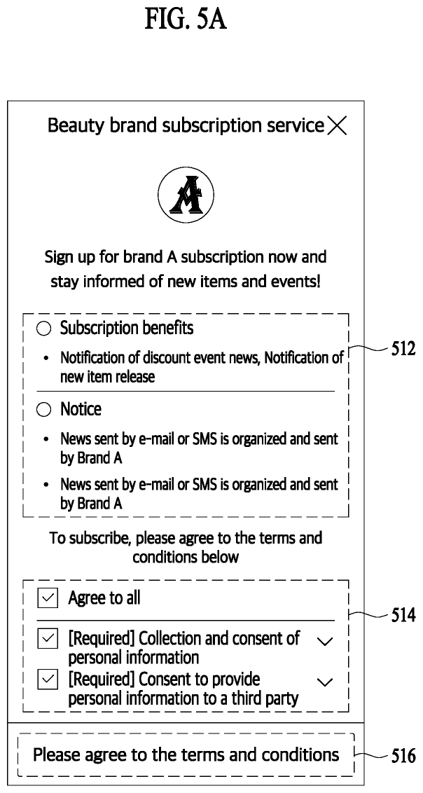

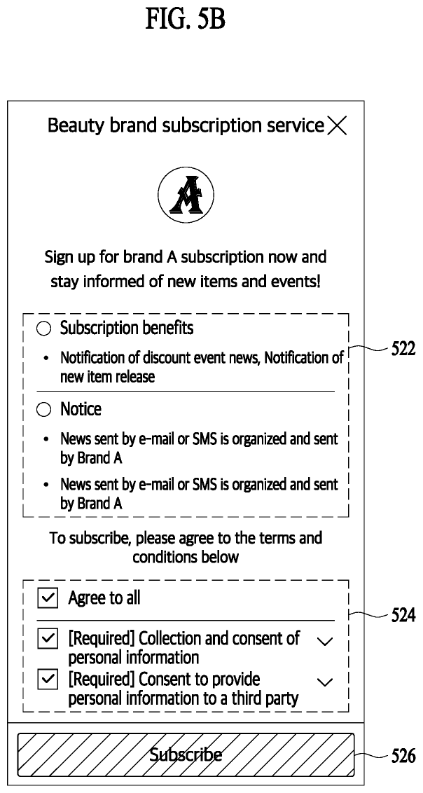

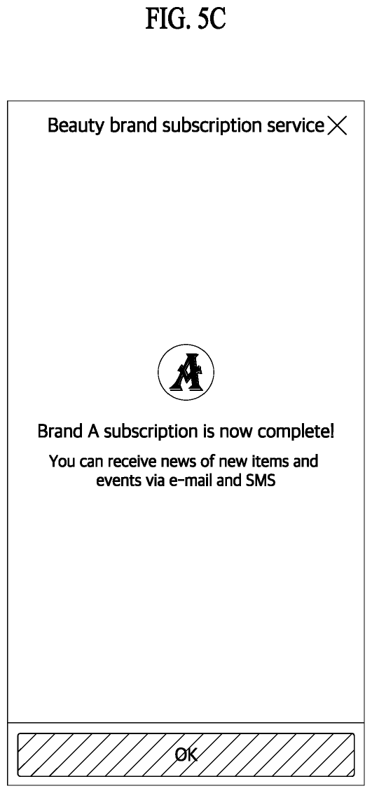

FIGS. 5A to 5C are diagrams schematically illustrating a user interface screen related to a brand membership subscription provided by an electronic apparatus according to an example embodiment of the present disclosure.

According to various example embodiments, the electronic apparatus 100 may provide brand membership subscription guide screen information as illustrated in FIGS. 5A and 5B based on a user input for requesting a subscription to a specific brand membership. For example, the electronic apparatus 100 may switch the screen to an individual brand membership subscription guide page upon confirming receipt of a user input for the link or icon (e.g., brand A subscription request button 411 in FIG. 4A or 421 in FIG. 4B, and brand L subscription request button 422 in FIG. 4B) for requesting a registration (subscription) for a specific brand membership on a user interface (refer to FIGS. 4A and 4B) displaying item purchase completion information.

For example, the electronic apparatus 100 may provide detailed benefit information 512 and 522 (and/or notice information related to subscription) that can be received when subscribing to the brand membership (e.g., brand A membership) on the user interface related to the subscription to the brand membership. For example, the detailed benefit information may include at least one of discount benefit information that can be applied when purchasing an item of the brand (e.g., 5% discount is applied collectively when purchasing a brand A item, etc.) or information about the launch of a new item of the brand (e.g., providing a priority purchase opportunity for brand A new items, etc.). In addition, although not shown in FIG. 5A, the electronic apparatus 100 may also provide, on the brand membership benefit-related user interface, recommended item information corresponding to the brand (brand A), may provide information on the subscription condition of the brand membership, or may provide conditions for each level and benefit information for each level of the brand membership. Meanwhile, the electronic apparatus 100 may further provide information 514, 516, 524, and 526 for requesting input of a user's agreement to the terms and conditions required for subscription application in the brand membership subscription-related user interface (page).

For example, when it is confirmed that all consent inputs for at least one consent article required for subscription to the brand membership in the terms and conditions agreement-related article 514 of the brand membership subscription-related page as shown in FIG. 5A have been received (checked), the electronic apparatus 100 may switch a portion where a message requesting agreement to the terms and conditions of FIG. 5A (e.g., “Please agree to the terms and conditions” 516) to display a virtual button (e.g., “Subscribe” button 526) portion corresponding to the request for subscription application. As described above, when a user input to the “Subscribe” button 526 is received while the screen has been switched from FIG. 5A to FIG. 5B, the electronic apparatus 100 finally switches the screen to a user interface indicating that the subscription to the corresponding brand membership has been completed as shown in FIG. 5C.

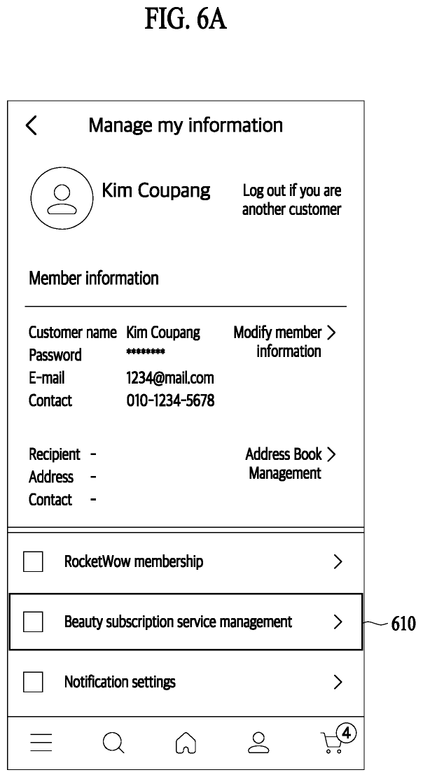

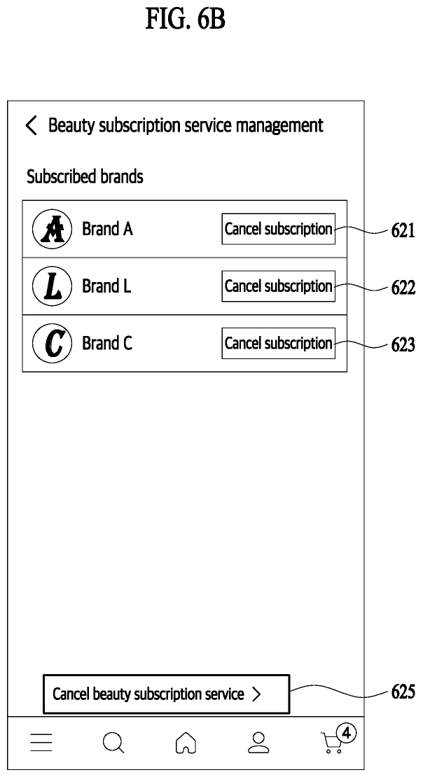

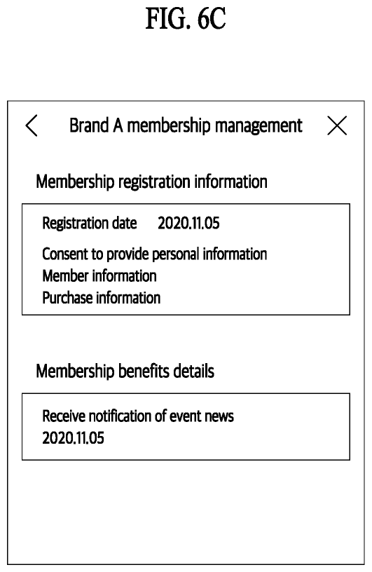

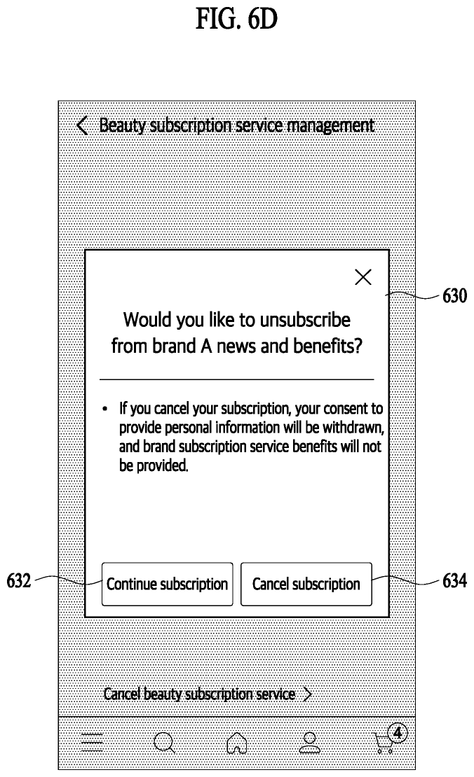

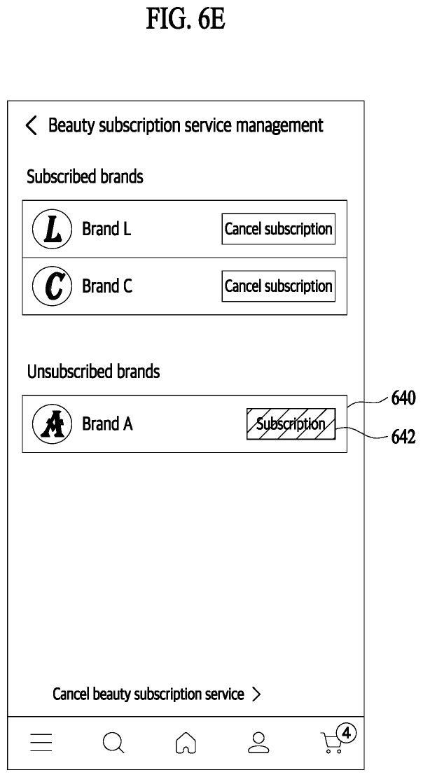

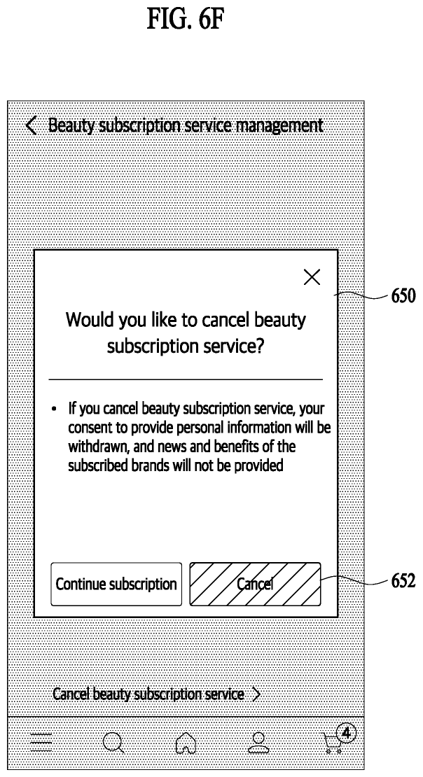

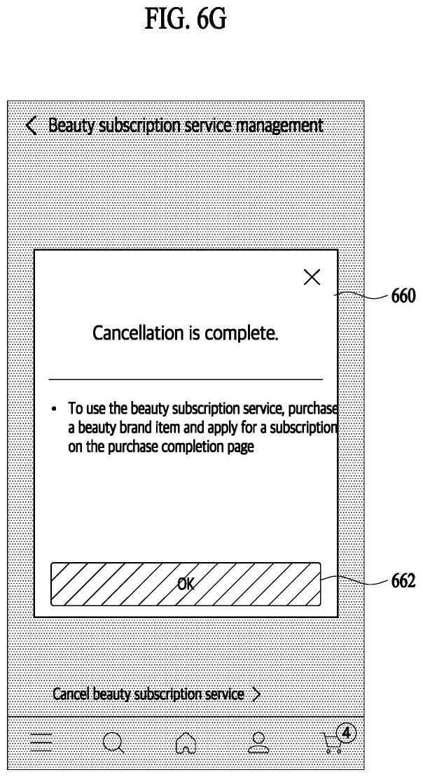

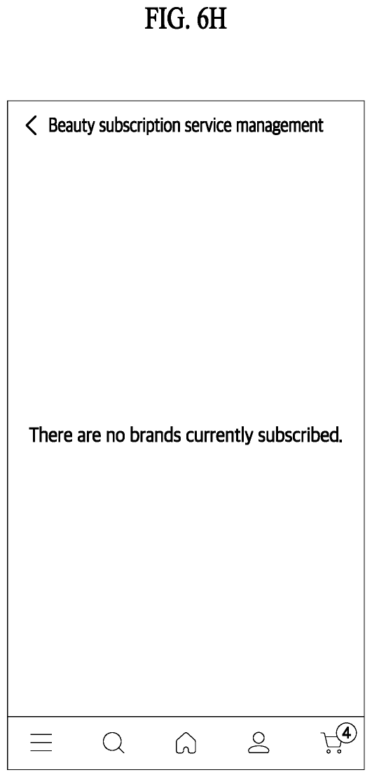

FIGS. 6A to 6H are diagrams schematically illustrating a user interface related to management of brand membership provided by an electronic apparatus according to an example embodiment of the present disclosure.

According to various example embodiments, the electronic apparatus 100 may provide membership-related information on one or more brands to which the user subscribed or is eligible for subscription, and, upon receipt of an input for applying for subscription or canceling subscription to the one or more brand memberships from the user, it may perform related functions.

For example, the electronic apparatus 100 may include a brand membership management menu item (for example, a “Beauty subscription service management” item 610) on a page (user interface) related to user information according to an example embodiment as illustrated in FIG. 6A. Upon receipt of user input information for entering the brand membership management menu, the electronic apparatus 100 may provide brand membership list information as illustrated in FIG. 6B, 6E, or 6H. For example, the user information-related page may be a page displaying information related to purchase of a user or may include a page for changing and setting user information. According to an example embodiment, the brand membership management menu may be configured as a management menu for membership-related services of brands belonging to a category with a high user interest (e.g., beauty brands).

Referring to FIG. 6B, the electronic apparatus 100 according to an example embodiment may provide list information of at least one brand membership in the brand membership management menu (e.g., “Beauty subscription service management” menu). For example, the brand membership list information may be related to one or more brands (e.g., brand A, brand L, brand C) to which the user has subscribed (currently subscribed). Alternatively, unlike as shown in FIG. 6B, the brand membership list information according to another example may be about list information (e.g., see FIG. 6E) on one or more memberships to which the user is eligible for subscription as the user completes the purchase of the related item, that is, one or more memberships to which the user can subscribe.

For example, when receiving an input for selecting a specific brand membership (e.g., brand A membership) by a user from the user interface as shown in FIG. 6B, the electronic apparatus 100 may provide information related to the brand membership selected by the user as a user interface as shown in FIG. 6C. For example, the selection input of the specific brand membership may correspond to an input corresponding to a portion in which a mark or brand name of the specific brand is displayed.

For example, referring to FIG. 6C, when a specific brand membership is selected from the brand membership management menu, the electronic apparatus 100 may provide at least some of user subscription information related to the corresponding brand membership (e.g., subscription date information, personal information consent information, etc.), purchase information, member information (e.g., member level information), and detailed benefit information (e.g., benefit information that the user can receive and/or benefit information that the user has received so far).

Meanwhile, as shown in FIG. 6B, the electronic apparatus 100 may also provide a user interface that provides a function of canceling the subscription of at least some of the selected brand membership. When a request to cancel the subscription for a specific brand membership or the entire brand membership is received, the setting can be changed and managed so that related benefit information is no longer provided for the brand membership. In one example, when a subscription request or subscription cancellation request for a specific brand membership is received from a user, the electronic apparatus 100 may also transmit the user's subscription information or subscription cancellation information to the external apparatus (or external apparatuses) corresponding to each brand sales company.

For example, when a subscription request for a specific brand membership is received from a user, the electronic apparatus 100 according to an example embodiment provides information related to the subscription request to an external apparatus (e.g., an external apparatus corresponding to a brand seller) that manages the brand membership and may obtain information related to subscription approval from the external apparatus. For example, the electronic apparatus 100 may provide the external apparatus that manages the brand membership with at least some of personal information of the user (e.g., user identification information, user authentication information, user address information, phone number information, and input information regarding personal information provision consent, user terminal-related information, membership subscription request date and time information, user purchase history information, etc.) stored in the electronic apparatus 100 as information related to the subscription request. Also, the electronic apparatus 100 may receive subscription approval notification information and benefit information given according to subscription approval from the external apparatus. Meanwhile, the external apparatus may, upon approval for subscription to the brand membership, transmit benefit information (e.g., new item release information, brand item discount information, brand membership-related level, etc.) related to the brand membership directly to the user terminal 200 corresponding to the user so that a notification push can be provided to the user terminal 200 side. For example, the external apparatus provides the electronic apparatus 100 with the brand membership-related benefit information to control to output a notification push related to the benefit information to the user terminal 200 through a web page or an application provided from the electronic apparatus 100 to the user terminal 200, or control to output a notification push related to the benefit information to the user terminal 200 through a web page or application (or SMS message, etc.) provided by itself. Meanwhile, as described above, when a request input for canceling the subscription of the brand membership is received from the user, the electronic apparatus 100 transmits the related subscription cancellation request information to the external apparatus and may transmit an instruction to restrict the notification push of benefit information related to the brand membership and/or a request to destroy personal information corresponding to the user.

Referring again to FIG. 6B, the electronic apparatus 100 may provide a menu button (e.g., “Cancel subscription” menu 621, 622 or 623) related to canceling a subscription (or unsubscription) for each brand membership on the display screen of the brand membership list information, and may also provide a menu button (e.g., “Cancel beauty subscription service” menu 625) related to canceling a subscription (or unsubscription) for all subscribed brand memberships. For example, the function related to canceling the subscription for the entire brand memberships to which the user has subscribed may correspond to the function of canceling the subscription for all brand membership(s) to which the user has subscribed or may correspond to the function of canceling the subscription for brand membership(s) belonging to a specific category (e.g., cosmetics) among brands to which the user has subscribed.

For example, when the electronic apparatus 100 receives a user input for canceling the registration (subscription) to the membership of the specific brand (e.g., brand A) (e.g., a user input corresponding to the cancel subscription menu button 621 of the brand A), the electronic apparatus 100 may switch to provide a user interface screen for reconfirming to the user whether to cancel the membership registration (subscription) of the corresponding brand (e.g., brand A), as shown in FIG. 6D. For example, the user interface screen for reconfirming whether to cancel the subscription of the specific brand membership may be provided in the form of a pop-up screen 630 in which predetermined notification information related to the subscription cancellation of the brand A membership and a menu for finally confirming the intention to cancel the subscription of the brand membership (e.g., a “Cancel subscription” menu button 634 and a “Continue subscription” menu button 632) are displayed.

For example, when the user clicks the “Cancel subscription” menu button 634 on the interface screen related to the subscription cancellation of the brand A membership in FIG. 6D, the electronic apparatus 100 may cancel the registration (subscription) of the brand A membership based on the user input, and related information may be transmitted to an external apparatus (e.g., a brand membership management server corresponding to brand A membership).

Meanwhile, as a result of canceling the registration (subscription) of the brand A membership, the electronic apparatus 100 may display the brand A on list information (e.g., “Unsubscribed brands” 640) on at least one membership brand of which subscription is canceled on the interface screen displaying the brand membership list information as shown in FIG. 6E. In addition, by providing a “Subscribe” menu button 642 for each brand membership included in the brand membership list of which subscription has been canceled, it is possible to induce the user to (re)subscribe to each brand membership. Meanwhile, in various example embodiments, the information on the list of “Unsubscribed brands” may be replaced with information on the list of “Brands available for subscription”. The list of “Brands available for subscription” may not only include the brand membership to which the user has previously subscribed and then canceled the subscription but also the brand membership(s) that the user is eligible for subscription but has not previously subscribed. In some example embodiments, the electronic apparatus 100 may differentiate and display the brand memberships of which has been canceled and other brand memberships based on the user's subscription history.

Meanwhile, the electronic apparatus 100 may provide a function to collectively cancel subscriptions to respective brand memberships included in the brand membership list (or the brand membership list including the subscribed brand memberships belonging to a specific category) to which the user subscribed (registered by the user). For example, upon receiving a user input for canceling the subscription of the entire brand membership (e.g., a user input corresponding to “Cancel beauty subscription service” menu button 625) in FIG. 6B (or FIG. 6E), the electronic apparatus 100 provides a page screen including the user reconfirmation request pop-up information 650 related to the subscription cancellation as shown in FIG. 6F. If an input on the “Cancel” menu button 652 is received from the user on the corresponding page screen, the screen may be switched to a page including pop-up information 660 for informing completion of subscription cancellation as illustrated in FIG. 6G. In addition, as a user input corresponding to the confirmation button 662 is received on the page screen shown in FIG. 6G, the electronic apparatus 100 may display a page screen related to the updated brand membership list information as shown in FIG. 6H. For example, as shown in FIG. 6H, in response to a user input requesting to cancel subscriptions for all brand memberships being subscribed, the electronic apparatus 100 may output information indicating that there are no brand memberships to which the user subscribed.

For example, the electronic apparatus 100 may process related information by differently treating a case in which a user cancels only a subscription to a specific brand membership and a case in which all subscriptions for all brand memberships are canceled. For example, when an individual subscription (registration) cancellation request for a specific brand membership occurs, the electronic apparatus 100 may provide an external server related to the brand membership corresponding to the canceled brand membership with information on an instruction to withdraw the user's consent to provide and use personal information in response to the request. On the other hand, when a request for cancellation of all subscriptions (registrations) for all brand memberships subscribed by the user occurs, that is, when a cancellation request for the service itself related to brand membership occurs, the electronic apparatus 100 may provide each of the external server(s) corresponding to each of the entire brand memberships with information on an instruction to withdraw the user's consent to provide personal information, and may create and manage information related to an instruction to withdraw the user's consent to provide and use personal information stored in the electronic apparatus 100. For example, the electronic apparatus 100 may perform a task of deleting pre-stored information related to the brand membership service of the user based on the instruction to withdraw the user's consent to provide and use personal information in the electronic apparatus 100.

The electronic apparatus 100 according to various example embodiments of the present disclosure induces a user to subscribe to a brand membership related to a predetermined item purchased by the user, provides related benefit information or recommends related brand items, so as to recommend items that the user is likely to be interested or provide related benefit information to make the user feel satisfied.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The electronic apparatus or user terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

1. An information providing method comprising:
generating, by an electronic apparatus, a first user interface comprising one or more items to be purchased and a first button configured to, upon selection, purchase the one or more items, wherein the purchase is associated with a user account;
receiving a first user interaction comprising selection of the first button to complete a purchase of the one or more items;
obtaining information on at least one purchased item of the one or more purchased items;
determining brand membership-related information corresponding to the at least one purchased item, wherein the brand membership-related information comprises subscription benefit information;
generating, based on a determination of the brand membership-related information associated with the one or more purchased items and the subscription benefit information, a second user interface comprising at least part of the brand membership-related information and at least a second button associated with the at least one available brand membership;
receiving a second user interaction comprising selection of the at least the second button; and
generating a third user interface with subscription guide information, corresponding to the brand membership associated with the at least the second button, and a third button configured to, upon selection, subscribe the user account to the brand membership associated with the at least the second button,
wherein the subscription guide information comprises at least part of the brand membership-related information and the subscription benefit information, and
wherein the subscription benefit information provided in the second user interface is selected from a list of all subscription benefit information associated with all brand membership-related information from the one or more purchased items.

2. The information providing method of claim 1,
wherein the obtaining of the information on the at least one purchased item comprises obtaining information on at least one item purchased by a user.

3. The information providing method of claim 2, further comprising:
identifying whether the user account subscribes to the brand membership,
wherein the generating the second user interface is further based on an identification of whether the user account subscribes to the brand membership.

4. The information providing method of claim 1, wherein the determining of the brand membership-related information comprises identifying the brand membership-related information corresponding to the at least one purchased item among a plurality of brand membership-related information corresponding to a plurality of items stored in a database in advance.

5. The information providing method of claim 4, wherein the generating of the at least part of the brand membership-related information comprises providing information associated with a predetermined brand membership to which the user account is to subscribe based on a purchase history information associated with the user account.

6. The information providing method of claim 2, wherein the generating of the at least part of the brand membership-related information comprises providing brand membership-related information corresponding to at least one of delivery address information or payment area information related to the purchase of the at least one purchased item.

7. The information providing method of claim 2, wherein the generating of the at least part of the brand membership-related information comprises determining whether to provide the brand membership-related information in response to a completion of delivery of the at least one purchased item to the user based on delivery information of the at least one purchased item.

8. The information providing method of claim 1, wherein the generating of the at least part of the brand membership-related information comprises providing at least part of the brand membership-related information based on a user input for confirming a purchase of the at least one purchased item.

9. The information providing method of claim 1, wherein the generating of the at least part of the brand membership-related information comprises providing the brand membership-related information on a user interface displaying purchase completion notification information of the at least one purchased item.

10. The information providing method of claim 1, wherein the generating of the at least part of the brand membership-related information comprises:
identifying item category information corresponding to the at least one purchased item; and
providing the at least part of the brand membership-related information based on the item category information.

11. The information providing method of claim 1,
wherein generating the second user interface is further based on a specified condition comprising at least one of a payment count-related condition, a payment amount-related condition, and a payment method-related condition for the at least one purchased item or at least one among other items of a brand corresponding to the at least one purchased item, and
wherein the at least part of the brand membership-related information of the second user interface satisfies the specified condition.

12. The information providing method of claim 3, further comprising:
transmitting, based on the generating of the subscription guide information and upon receiving subscription request information for the brand membership from the electronic apparatus, at least part of the subscription request information to an external server corresponding to the brand membership;
receiving benefit information related to the brand membership from the external server; and
outputting, based on the received benefit information related to the brand membership, notification information related to the brand membership to the electronic apparatus.

13. The information providing method of claim 12, further comprising receiving, by the electronic apparatus, a command to output the notification information related to the brand membership from at least one of the electronic apparatus and the external server.

14. An electronic apparatus comprising:
a communication module;
a database; and
a processor electrically connected to the database,
wherein the processor is configured to:
generate, by an electronic apparatus, a first user interface comprising one or more items to be purchased and a first button configured to, upon selection, purchase the one or more items, wherein the purchase is associated with a user account;
receive a first user interaction comprising selection of the first button to complete a purchase of the one or more items;
obtain information on at least one purchased item of the one or more purchased items purchased by a specific user;
determine brand membership-related information corresponding to the at least one purchased item, wherein the brand membership-related information comprises subscription benefit information;
generate, based on a determination of the brand membership-related information associated with the one or more purchased items and the subscription benefit information, a second user interface comprising at least part of the brand membership-related information and at least a second button associated with the at least one available brand membership;
receive a second user interaction comprising selection of the at least the second button; and
generate a third user interface with subscription guide information corresponding to the brand membership associated with the at least the second button, and a third button configured to, upon selection, subscribe the user account to the brand membership associated with the at least the second button,
wherein the subscription guide information comprises at least part of the brand membership-related information and the subscription benefit information, and
wherein the subscription benefit information provided in the second user interface is selected from a list of all subscription benefit information associated with all brand membership-related information from the one or more purchased items.

15. The electronic apparatus of claim 14, wherein the generation of the second user interface is further based on a specified condition comprising a purchase history information of the user account or delivery information of the at least one purchased item, and wherein the generation of the second user interface is further based on an identification of whether the user account subscribes to the brand membership.
